(19) United States
(12) Patent Application Publication
(10) Pub. No.: US 2002/0196230 A1
(43) Pub. Date: Dec. 26, 2002

(54) Remote viewing system incorporating relative directional indication

(76) Inventor: David A. Struyk, Excelsior, MN (US)

Correspondence Address: SCHROEDER & SIEGFRIED, 222 SOUTH NINTH STREET, SUITE 2870, MINNEAPOLIS, MN, 55402, US

(21) Appl. No.: 10/003,518

(22) Filed: Oct. 30, 2001

Related U.S. Application Data
(60) Provisional application No. 60/300,106, filed on Jun. 22, 2001.

(51) Int. Cl. G09G 5/08

(52) U.S. Cl. 345/158

(57) ABSTRACT

A viewing system is presented in which both a remotely located video camera and a separate video display each incorporate an electronic compass. An electronic circuit calculates the difference between the two compass headings and displays a relative direction indicator on the display. The indicator can thus display the viewing direction of the camera relative to the viewing orientation of the display. This is especially useful in determining the viewing direction of a non-stationary remote camera in applications where the display is also non-stationary, such as in underwater viewing applications where the camera is suspended by a cable beneath a boat, and the display is located within the boat.

### CROSS REFERENCE TO RELATED APPLICATIONS

This application is an application for a patent which is also disclosed in Provisional Application Serial No. 60/300,106, filed on Jun. 22, 2001 by the same inventor, namely David A. Struyk, and entitled “REMOTE VIEWING SYSTEM INCORPORATING RELATIVE DIRECTIONAL INDICATION,” the benefit of the filing date of which is hereby claimed.

### BACKGROUND OF THE INVENTION

The present invention relates generally to the art of remote viewing systems, and more specifically to a viewing system having relative directional indication for maintaining awareness of the viewing direction of a camera from a remote and potentially movable display.

Viewing systems, employing remote video cameras linked electrically to video displays, are becoming increasingly more popular. In systems where the camera and display can be positioned independently, it is not always easy to determine in which direction the camera is pointing, especially relative to the display. In applications, such as underwater viewing systems, it can be useful to know which direction the camera is pointing. In applications such as this, the camera may be suspended on a flexible cable, with no knowledge as to the camera's orientation many feet below the surface. Additionally, the monitor may be located on a movable platform, such as within a boat on the water, or even handheld within the movable platform, further complicating the determination as to what direction the camera is viewing.

The importance of knowing the direction of view of the remote camera is especially great in applications such as fishing, search and recovery, well and sewer inspection, and exploratory research. Indeed, the potential applications for such a system are many.

In fishing, it is important to know the direction of view in order to determine the direction of underwater structure and the potential location of fish. In ice fishing, it is common to fish through one hole in the ice with the camera lowered through a second hole. Locating the fishing lure is typically accomplished by rotating the cable to the camera until the lure or bait is found. This is, however, complicated by the fact that the water may be cloudy or murky.

For search and recovery operations, inspection, and exploration applications, the importance of directional indication is obvious. In order to provide for complete or sufficient searching and inspection, it is important to be aware of the direction of viewing.

### BRIEF SUMMARY OF THE INVENTION

In a typical remote viewing application, a remote image capture device, such as a video camera, is electrically linked to a video display unit. The video camera is typically suspended out of sight by a long flexible cable, thus impeding directional awareness and making orientation control of the camera unit difficult. Additionally, the video display, or monitor, may also be movably located, or even handheld, causing additional problems in control and directional awareness. Wireless remote viewing systems are also contemplated, which may potentially enhance the above-stated problems even further.

If an electronic compass module is included within the video camera housing, the magnetic, or absolute, viewing direction of the camera can be readily determined. However, since the video display may also be movably located, the absolute viewing direction of the camera may not always be beneficial. Therefore, by adding a second electronic compass module within the video display housing, the relative viewing direction, that is, the direction the camera is viewing relative to the direction the display or other known object is oriented, may be determined. This direction may then be indicated on the display unit, such as overlayed within the video image.

In accordance with the present invention, the use of a differential compass in a remote viewing system is contemplated to provide the camera operator with an indication of the viewing direction of the camera relative to a known directional orientation of the display, or some other potentially movable object (i.e., boat, platform). This is accomplished by mounting a first electronic compass module in the camera housing, and a second electronic compass module preferably in the video display housing, where the difference between the absolute heading of each may be calculated and used to determine the relative directional orientation therebetween.

The camera compass module calculates its heading via the use of a pair of orthogonally mounted compass sensors, such as magnetoresistive or magnetoinductive sensors. These sensors are sensitive to the earth's magnetic field and provide an electrical response as a function of their orientation. The sensors are configured within an electronic circuit capable of appropriate scaling and measurement. Through the use of suitable analog to digital conversion, the camera compass heading is calculated by a small microcontroller located within the camera housing. This heading is then transmitted up the cable to the display unit by suitable means.

Located within the video display housing is a second set of orthogonally mounted compass sensors, and suitable electronic circuitry capable of determining the magnetic heading of the display unit and receiving data transmitted by the camera unit. This compass heading is then subtracted from the compass heading transmitted by the camera to determine the relative compass heading, or difference angle of the camera/display system. This relative heading is then overlayed on top of the video signal for display within the video screen.

A rotating pointer, around the perimeter of the screen, has been found to be a useful method of indicating the viewing direction of the camera relative to the orientation direction of the display. For example, if both the camera and the display are facing in the same direction, then a small arrow pointing up is positioned at the top center of the screen. If the camera is pointing rearward relative to the display, the arrow is positioned pointing downward at the lower center of the screen. Likewise, if the camera is pointing left or right relative to the display, then the arrow is positioned accordingly. The arrow is actually adjusted continuously around the perimeter to show orientation at all possible angles. For example, the arrow would be at the upper right corner of the display if the camera were pointing at 45 degrees clockwise relative to the position of the display. Preferably, the arrow is displayed on a contrasting background which moves with the arrow such that the arrow is readily viewable on the display at all times, regardless of the relative brightness or darkness of the overall display image. This provides for a very intuitive display which is easy to view without greatly obscuring the video image which is being transmitted from the camera.

Additional information relative to camera operation may also be displayed within the same system, such as temperature at the camera, depth of the camera, absolute magnetic heading of the camera, or GPS (global positioning) location information. While visual indication of the relative camera viewing direction and/or other data is considered preferable, audio or other sensory indicators are certainly conceivable. For example, a small pressure sensor may be incorporated within the camera housing to measure water pressure at the camera position. Depth, which can be easily converted from water pressure, may then also be calculated and displayed on the same video screen.

### BRIEF DESCRIPTION OF THE DRAWINGS

These and other objects and advantages of the invention will more fully appear from the following description, made in connection with the accompanying drawings wherein like reference characters refer to the same or similar parts throughout the several views, and in which:

FIG. 1 is a diagrammatical block diagram of a remote viewing system with a video display monitor and remote camera incorporating a differential compass system in accordance with my invention;

FIG. 2 is an electrical schematic of the preferred embodiment of the camera compass module constructed in accordance with my invention;

FIG. 3A is an electrical schematic showing a portion of the preferred embodiment of the display compass module constructed in accordance with my invention, including the microcontroller for the display compass module, as well as its electronic compass, power supply, and mode switches;

FIG. 3B is continuation of the electrical schematic for the display compass module as shown in FIG. 3A, showing the preferred form of the on-screen-display circuitry.

FIG. 4 is a flow diagram showing the preferred operation of the camera compass module disclosed in FIG. 2 above; and

FIG. 5 is a flow diagram showing the preferred operation of the display compass module disclosed in FIGS. 3A and 3B above.

### DETAILED DESCRIPTION OF THE INVENTION

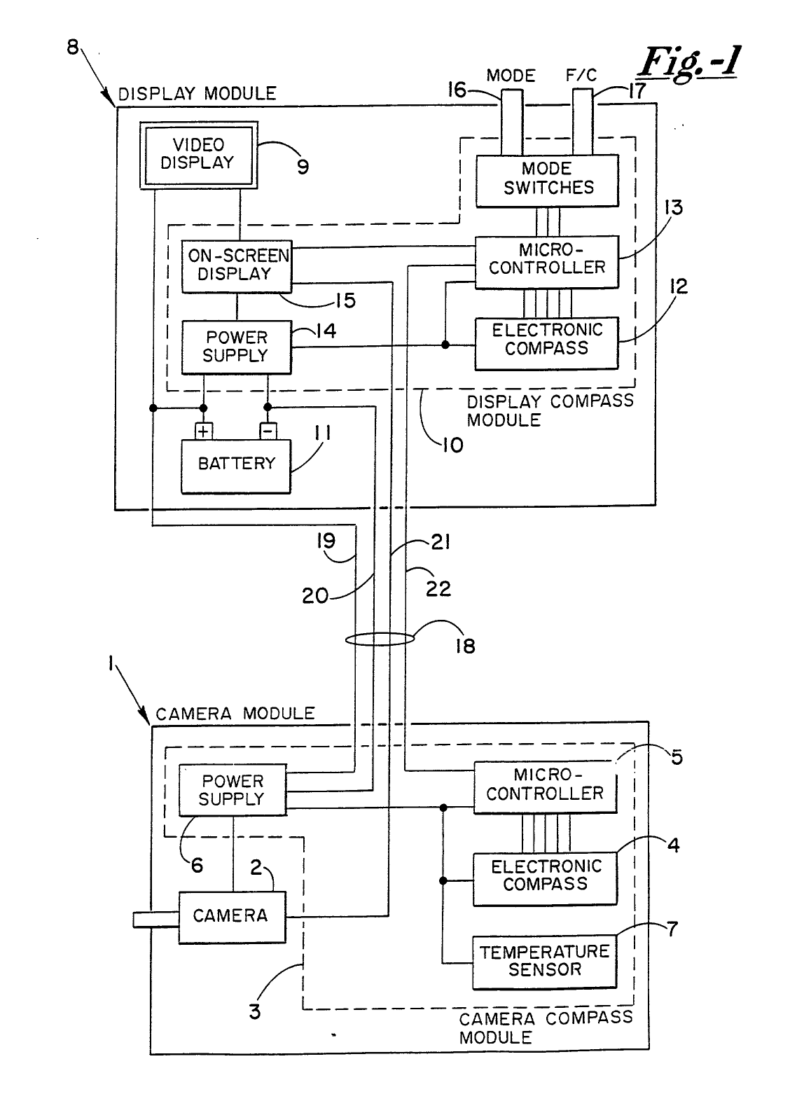

The block diagram shown in FIG. 1 displays the basic configuration of my improved remote viewing system incorporating relative directional indication. Located within the camera module 1 is an image capture device or camera 2, and camera compass module 3. The camera compass module 3 is comprised of an electronic compass 4, microcontroller 5, power supply 6, and optional temperature sensor 7. Located within the display module 8 is a video display 9, display compass module 10, and power source 11. The display compass module 10 comprises a similar electronic compass 12, microcontroller 13, and power supply 14 as utilized in the camera compass module 3, but also contains on-screen-display (OSD) electronics 15, and mode switches 16 and 17.

Switches 16 and 17 are used to select various operating modes. Switch 16 selects display modes such as RELATIVE, ABSOLUTE, TEMPERATURE ONLY, and OFF. Switch 17 is used to select between Fahrenheit and Celsius temperature display. These display module components are located within a housing separate from that of camera module 1, but are connected to camera module 1 by means of a cable 18 which contains conductors 19 and 20 for supplying power to the camera module 1 from the display module 8, as well as conductors 21 and 22 for transmitting the video and data signals from the camera module 1 to the display module 8.

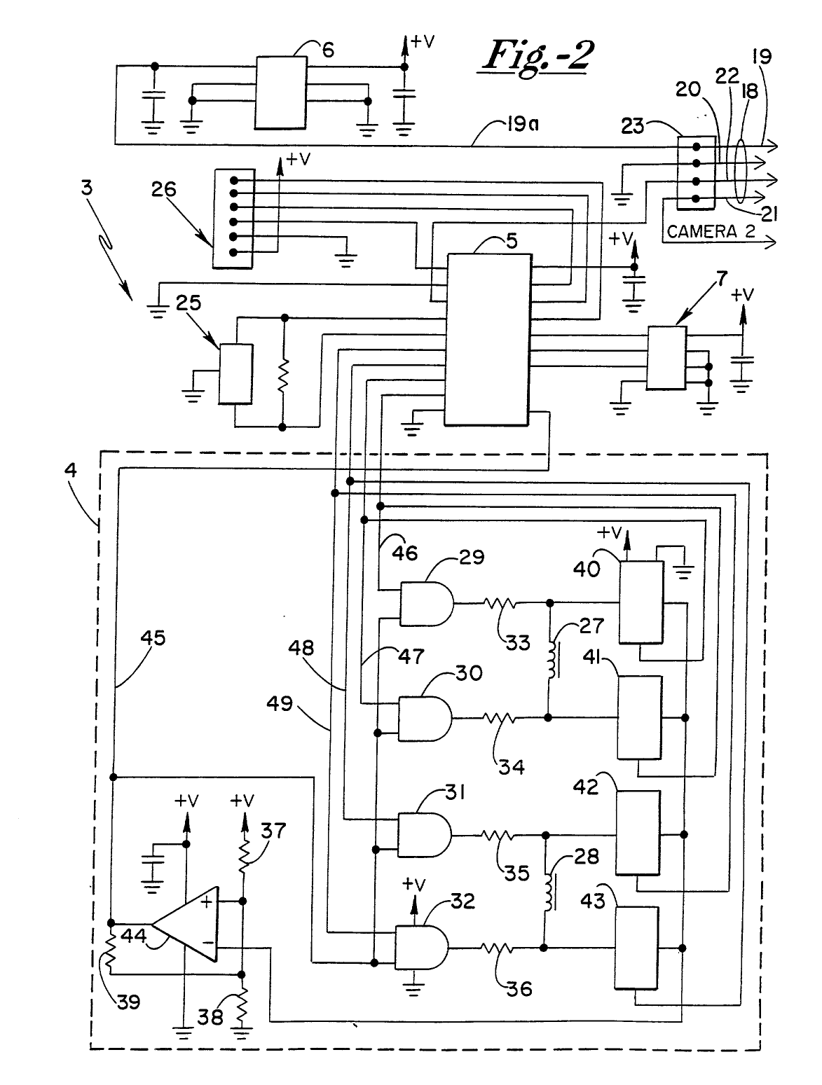

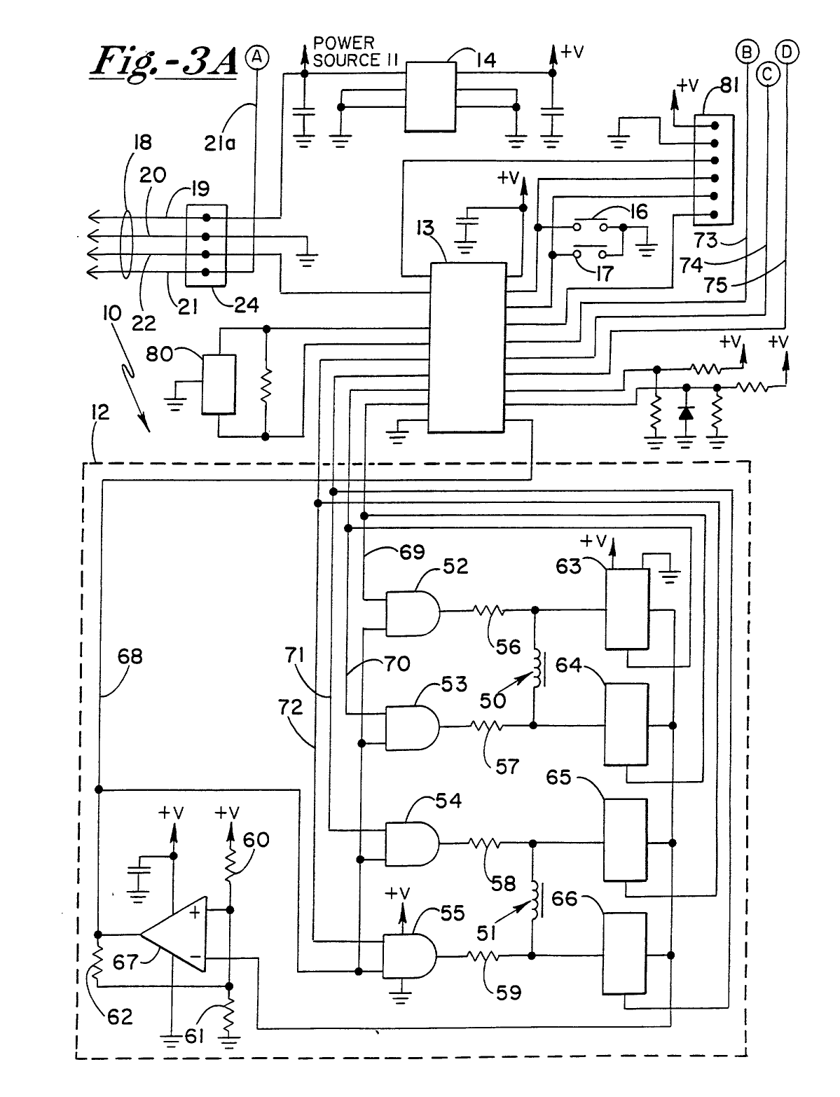

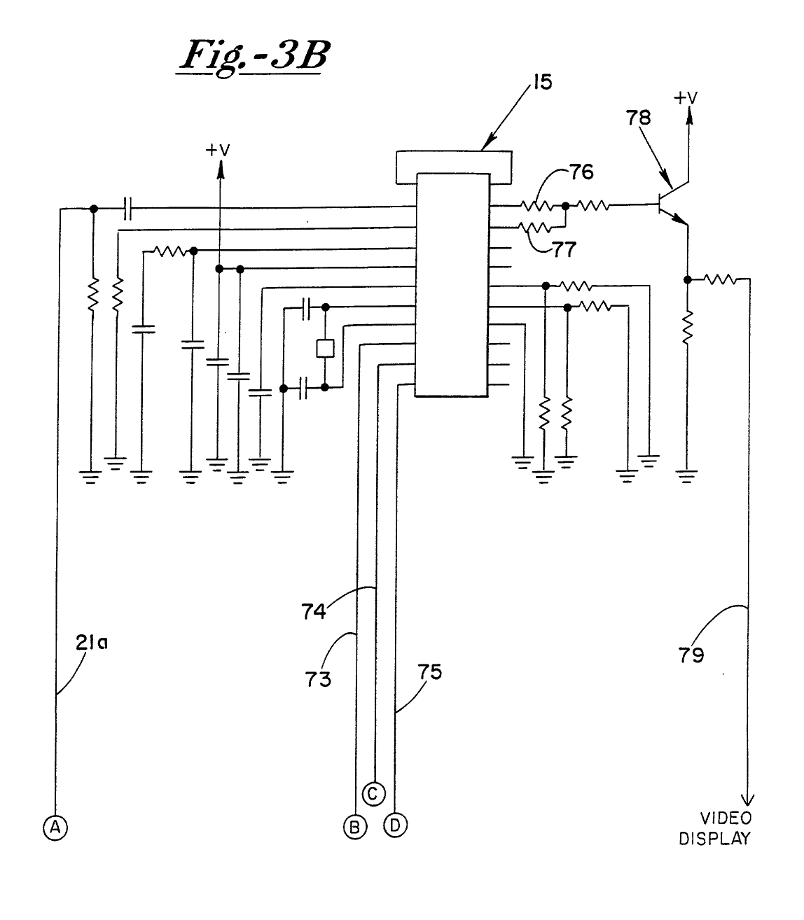

FIG. 2 is an electrical schematic of a preferred embodiment of the camera compass module 3. As shown therein, power supply 6 is a typical 5-volt regulator deriving supply voltage for the camera compass module circuitry from the 12V system power source 11. As shown in FIGS. 2 and 3A, cable 18 is connected between output interface 23 of camera module 1 and input interface 24 of display module 8. Thus, power from source 11 is transmitted through cable 18 and along line 19a to power supply 6.

Microcontroller 5 is the central control element of the camera compass module 3. It controls the camera compass module circuitry, performs camera heading and temperature measurement calculations, and transmits the data along line 22 of cable 18 to the display module 8 via a built in UART (universal asynchronous receiver transmitter) in microcontroller 5. The UART sends the data asynchronously, at a predetermined baud rate, so that a separate clock line is not necessary. Oscillator 25 provides the timing clock for microcontroller 5, and programming of microcontroller 5 may be conducted through programming interface 26.

The electronic compass circuit 4, shown within the dashed box of FIG. 2, utilizes magneto-inductive sensors 27 and 28, such as those manufactured by Precision Navigation Inc. Such sensors and associated circuitry are covered under U.S. Pat. Nos. 4,851,775 and 5,239,264, and are more fully explained within those patents, the contents of which are incorporated herein by reference thereto. Alternatively, the compass circuit 4 could employ magnetoresistive, flux-gate, or Hall effect sensors, all of which are well known in the art.

The compass circuit 4, comprising AND gates 29-32, orthogonal sensors 27 and 28, resistors 33-39, switches 40-43, and comparator 44, is configured as an oscillator whose output frequency is a function of the applied magnetic field to the sensors. The frequency, output from comparator 44, is input on line 45 to the microcontroller 5, where the data is analyzed to determine the camera compass heading. Microcontroller 5, through lines 46-49 connected to AND gates 29-32, respectively, controls the selection and direction of which sensor, 27 or 28, is used in the oscillation. Each sensor 27 and 28 is operated in both the forward and reverse bias so that any residual offsets or temperature effects are cancelled.

The camera compass module 3 also includes temperature sensor 7, which outputs a digital value representative of temperature to the microcontroller 5. The temperature sensor 7 is typically located such that it protrudes through the housing of camera module 1, as shown in FIG. 1, so that it is able to perform an accurate measurement of the surrounding water or air, without being influenced by internal heat generated from the electronic circuitry within the housing.

FIGS. 3A and 3B disclose an electrical schematic of the preferred embodiment of the display compass module 10. The display compass module 10 is configured similarly to the camera compass module 3, with the exception that the display portion also includes a video onscreen-display (OSD) circuit 15 (shown in FIG. 3B). Accordingly, the electronic compass circuit 12, shown in the dashed box of FIG. 3A, also utilizes a pair of orthogonal magnetoinductive sensors 50 and 51, AND gates 52-55, resistors 56-62, switches 63-66, and comparator 67, which is configured as an oscillator whose output frequency is a function of the applied magnetic field to the sensor. The frequency, output from comparator 67 on line 68, is input to the microcontroller 13, where the data is analyzed to determine the magnetic heading of the display compass, and thus the established directional orientation of the display. Microcontroller 13, through lines 69-72 connected to AND gates 52-55, respectively, also controls the selection and direction of which sensor, 50 or 51, is used in the oscillation, and each sensor 50 and 51 is operated in both the forward and reverse bias so that any residual offsets or temperature effects are cancelled.

As in the camera compass module 3, a typical 5-volt regulator 14 derives supply voltage for the display compass module circuitry from the 12-volt power source 11. Also, the timing clock for microcontroller 13 is provided by a similar oscillator circuit 80, and programming thereof may be accomplished through programming interface 81. As described previously, operating display modes are selected through activation of switches 16 and 17.

The microcontroller 13 is the central control element of the display compass module 10. It controls the display compass module circuitry, performs display heading calculations, receives camera heading and temperature data from the camera compass module through a built-in UART, and calculates therefrom the relative directional orientation (i.e., viewing direction) of the camera 2 as a function of the calculated directional heading of the video display 9. It then formats and sends this relative directional data to the OSD circuit 15, which is an integrated circuit specifically designed to provide video overlay on an incoming video signal.

In the preferred embodiment, OSD circuit 15 is of the type manufactured by ST Microelectronics, P.N. STV5730A, and is configured pursuant to the data sheet and technical notes therefor. As shown in FIG. 3B, the incoming video image to OSD circuit 15 is received on line 21 a from the camera 2 through cable 18 extending between the camera and display modules. The relative directional data received from microcontroller 13 is input serially to OSD circuit 15 along lines 73, 74, and 75, where it is synchronized to the incoming video image and overlayed on top thereof. The resulting video image signal with overlayed relative directional indicator is then output from OSD circuit 15 on lines 76 and 77, and transmitted through transistor 78 to the display monitor 9 for viewing.

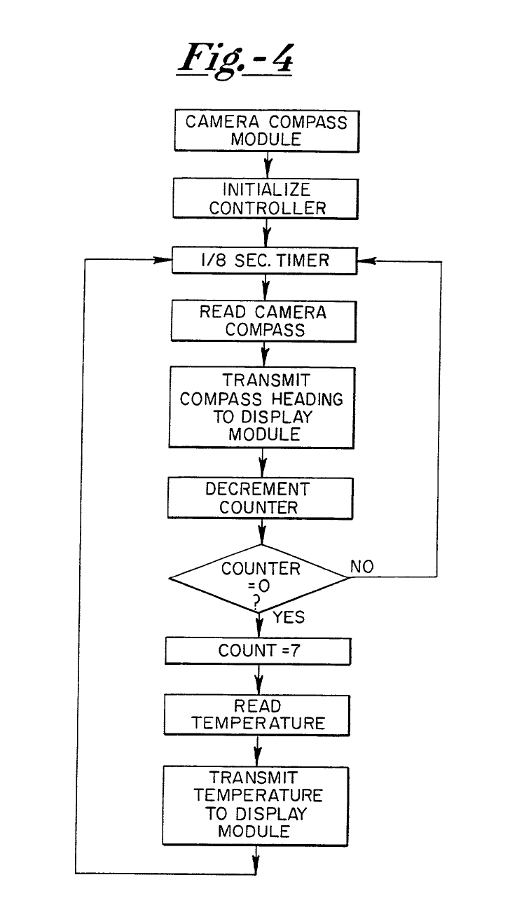

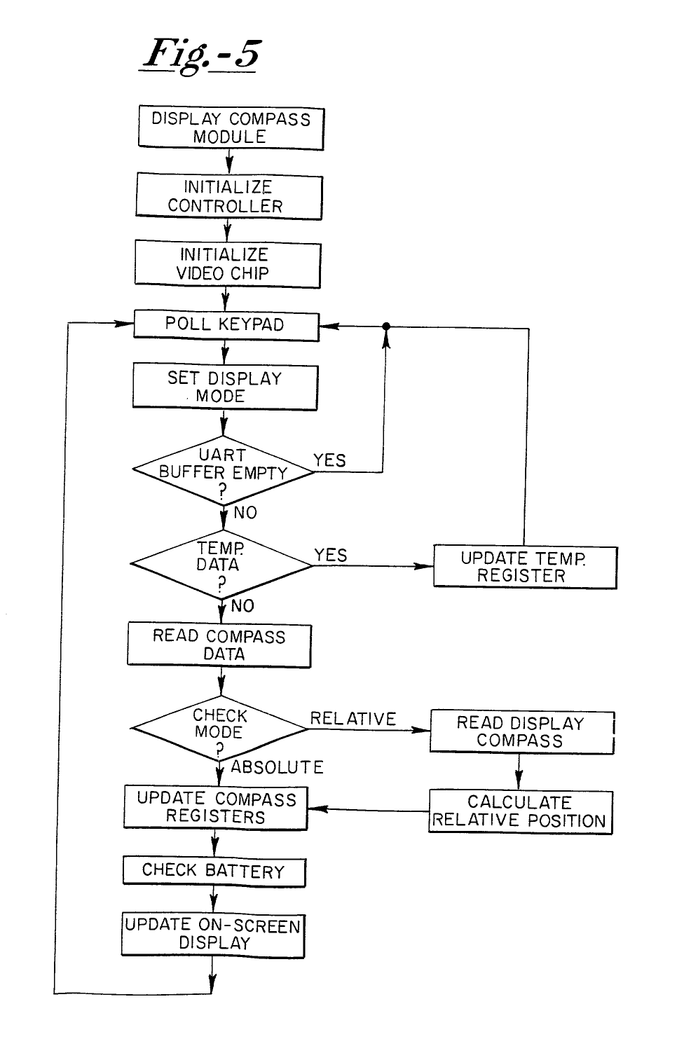

Operation of my improved remote viewing system with relative directional indication is shown best with reference to the flow diagrams of FIGS. 4 and 5. FIG. 4 is a flow diagram showing the flow of operation for the camera compass module 3. After the initial configuration of the appropriate registers of microcontroller 5, a ⅛ second timer provides the compass measurement interval time-base. Every ⅛ second a compass heading is determined. This heading is then transmitted through cable 18 to the display compass module 10 via a built in UART in microcontroller 5. The UART, which stores the camera heading information in its buffer, allows the camera compass module 3 to operate independently of the display compass module 10.

After each compass heading transmission, an 8-count counter is decremented to provide a time-base for temperature measurements. If the count has not yet reached zero, the program returns to the timer and awaits the next ⅛ second interval. This divide-by-8 counter thus sets a 1 second time-base for the temperature measurements. If the count is zero, the temperature sensor 7 is sampled by microcontroller 5 and a temperature measurement is performed. Once the temperature measurement is complete, it is also transmitted by microcontroller 5 via the UART to the display compass module 10, and the cycle repeats.

FIG. 5 is a flow diagram showing the flow of operation for the display compass module 10. Its operation, while similar, is more complicated than that of the camera compass module 3. After the initial configuration of appropriate microcontroller registers, the microcontroller 13 polls the keypad to determine if a mode selection switch has been pressed. If so, the appropriate display mode is selected. After each polling operation, the display mode is set and the UART buffer of microcontroller 13 is checked for receipt of a transmission from the camera module 1. Since the UART operates to receive data independently of microcontroller execution, the buffer may contain received data at any given time. If data is present, the data is read and its type is determined. If it is temperature data, the temperature data register is updated, and polling continues.

If the data received in the UART buffer is compass data, then the direction mode (absolute v. relative) must also be checked. If it is set for absolute mode, the compass registers are updated with the data from the camera compass module 3. If it is set for relative mode, the display compass module 10 is accessed, and the relative position is determined; that is, the viewing direction of the camera relative to the established directional orientation of the display.

To determine display orientation, compass measurements are performed in a similar fashion to that of the camera module 1. However, since microcontroller 13 continuously checks the UART buffer for received compass data, compass measurements to determine display orientation are not independently time-based, but rather are determined as a function of the camera compass data received. In other words, display orientation headings are determined synchronously with the receipt of camera compass heading data. The compass and display headings are then subtracted to determine relative direction, and the compass registers are updated accordingly with the relative direction data. Once updating of the compass register is complete, the battery condition may also be checked.

This information (direction, temperature and battery condition) is then configured within microcontroller 13 to be displayed by the OSD circuit 15. With reference to FIGS. 3A and 3B, it can be seen that this data from microcontroller 13 is sent serially to the OSD circuit 15 along lines 73, 74, and 75. The incoming video image, as sent from the camera module 1, is also input to OSD circuit 15. The OSD circuit 15 is capable of synchronizing to the incoming video image and overlaying text or graphics on top. The output from OSD circuit 15 is sent through lines 76 and 77 to the base of transistor 78, which provides isolation and drive through line 79 to typical 75-ohm video loads, such as display 9. Once updating the OSD circuit 15 is completed, keypad polling continues, thereby repeating the process for continuous display updates.

In the preferred embodiment, the relative heading information is used to determine the position of the displayed graphical arrows around the perimeter of the display screen. The temperature information is typically displayed in the lower right hand corner of the display. Using this display method, a typical screen image for a relative camera angle of 295 degrees would show an arrow pointing slightly forward of left relative to the display. If in absolute mode, the absolute heading and cardinal direction is also displayed, typically at the top center of the screen. For instance, an absolute camera angle of 130 degrees would include “130 SE,” since this is approximately southeast. 68F in the lower right of both images would indicate temperature measured in Fahrenheit at the camera.

The display is updated rapidly, several times per second, so that as the camera or display is moved, the indicators move smoothly to indicate the viewing direction changes.

It will, of course, be understood that various changes may be made in the form, details, arrangement, and proportions of the parts without departing from the scope of the invention which comprises the matter shown and described herein and set forth in the appended claims.

1. A remote viewing apparatus with relative directional indication, comprising:
(a) an image capture device;
(b) an image display device communicatively associated with said image capture device for receiving and displaying imagery data transmitted from said image capture device; and
(c) a relative direction indicator communicatively associated with said image capture device and said image display device for indicating a directional orientation of said image capture device relative to a directional orientation of said image display device.

2. The remote viewing apparatus of claim 1, wherein said relative direction indicator includes means for indicating a viewing direction of said image capture device relative to said directional orientation of said image display device.

3. The remote viewing apparatus of claim 1, wherein said relative direction indicator is constructed and arranged to overlay a graphical representation of said directional orientation of said image capture device within said imagery data being displayed on said image display device.

4. The remote viewing apparatus of claim 1, wherein said relative direction indicator includes means for determining the difference between a viewing direction of said image capture device and said directional orientation of said image display device, and indicating said viewing direction of said image capture device on said image display device based on the difference between said viewing direction of said image capture device and said directional orientation of said display device.

5. The remote viewing apparatus of claim 1, wherein said relative direction indicator includes an electronic compass module mounted on each of said image capture and said image display devices.

6. The remote viewing apparatus of claim 5, wherein said relative direction indicator calculates the difference between the magnetic heading of said electronic compass module on said image capture device and the magnetic heading of said electronic compass module on said image display device, and displays a graphical representation on said image display device of a viewing direction of said image capture device relative to said directional orientation of said image display device, based on said calculated relative directional difference therebetween.

7. The remote viewing apparatus of claim 5, wherein each said electronic compass module includes a pair of orthogonally-mounted compass sensors.

8. The remote viewing apparatus of claim 1, wherein said image display device is movable.

9. The remote viewing apparatus of claim 1, wherein said relative direction indicator provides a visible indication of a viewing direction of said image capture device relative to said directional orientation of said image display device.

10. The remote viewing apparatus of claim 1, including means for displaying on said image display device operational information relative to said image capture device other than said directional orientation thereof.

11. A remote viewing apparatus with relative directional indication, comprising:
(a) an image capture device;
(b) an image display device communicatively associated with said image capture device for receiving and displaying imagery data transmitted from said image capture device; and
(c) a relative direction indicator communicatively associated with said image capture device for indicating a viewing direction of said image capture device relative to a known movable directional orientation.

12. The remote viewing apparatus of claim 11, wherein said image display device is movable, and an established directional orientation of said image display device constitutes said known movable directional orientation from which said relative viewing direction of said image capture device is determined.

13. The remote viewing apparatus of claim 11, wherein an established directional orientation of said image display device determines said known movable directional orientation from which said relative viewing direction of said image capture device is determined.

14. The remote viewing apparatus of claim 13, wherein said relative direction indicator is constructed and arranged to display on said image display device an indicator of said viewing direction of said image capture device relative to said established directional orientation of said image display device.

15. The remote viewing apparatus of claim 14, wherein said viewing direction indicator displayed by said relative direction indicator on said image display device is composed of a peripherally disposed graphical arrow that is rotatable about the perimeter of said image display device in relation to the relative directional difference between said viewing direction of said image capture device and said established directional orientation of said image display device.

16. The remote viewing apparatus of claim 11, wherein said relative direction indicator provides a visible indication of said viewing direction of said image capture device relative to said known movable directional orientation.

17. The remote viewing apparatus of claim 11, wherein said relative direction indicator is comprised of a pair of electronic compass modules, one said compass module being carried by said image capture device, and the other said compass module being carried by said image display device.

18. The remote viewing apparatus of claim 17, wherein said relative direction indicator is constructed and arranged to calculate the difference between the magnetic directional orientation or one compass module relative to the other, for use in determining said viewing direction of said image capture device relative to an established directional orientation of said image display device.

19. The remote viewing apparatus of claim 11, including means associated with said image capture device for providing indication of operational information relative to said image capture device.

20. A remote viewing apparatus with relative directional indication, comprising:
(a) an image capture device having a first compass connected thereto;
(b) an image display device communicatively associated with said image capture device and having a second compass connected thereto; and
(c) a relative direction indicator communicatively associated with said first and second compasses, said relative direction indicator including means for determining and indicating the relative directional difference between the respective headings of said first and second compasses.

21. The remote viewing apparatus of claim 20, wherein said first and second compasses are comprised of electronic compass modules, each of which includes a pair of orthogonally disposed compass sensors.

22. The remote viewing apparatus of claim 20, wherein said relative direction indicator is constructed to indicate a viewing direction of said image capture device relative to a known directional orientation of said image display device, based on the relative directional difference between said first and second compasses.
